(19) United States
(12) Patent Application Publication
(10) Pub. No.: US 2015/0175469 A1
(43) Pub. Date: Jun. 25, 2015

(54) METHOD FOR PRODUCING TEMPERED GLASS

(71) Applicant: Nippon Electric Glass Co., Ltd., Shiga (JP)

(72) Inventor: Masashi Tabe, Shiga (JP)

(21) Appl. No.: 14/409,140

(22) PCT Filed: Jun. 19, 2013
(86) PCT No.: PCT/JP2013/066805

§ 371 Date: Dec. 18, 2014

(30) Foreign Application Priority Data
Jun. 21, 2012 (JP) 2012-139358

(51) Int. Cl. C03B 27/012; C03C 3/083; C03C 4/18; C03C 21/00

(52) U.S. Cl. CPC C03B 27/012; C03C 21/002; C03C 3/083; C03C 4/18; C03C 2204/00

(57) ABSTRACT

A method of manufacturing a tempered glass includes: subjecting a glass to be tempered to ion exchange treatment to obtain a tempered glass having a compressive stress layer; and subjecting the tempered glass to heat treatment at a heat treatment temperature of 300° C. or more and less than (a temperature of the ion exchange treatment+10° C.) so that a compressive stress (CS) of the compressive stress layer becomes from 120 to 1,200 MPa.

### TECHNICAL FIELD

The present invention relates to a method of manufacturing a tempered glass, and more particularly, to a method of manufacturing a cover glass for a cellular phone, a digital camera, a personal digital assistant (PDA), or a solar battery, or a substrate for a display, in particular, a touch panel display.

### BACKGROUND ART

Devices such as a cellular phone, a digital camera, a PDA, a touch panel display, a large-screen television, and contact-less power transfer show a tendency of further prevalence.

Hitherto, in those applications, a resin sheet such as an acrylic sheet has been used as a protective member for protecting a display. However, owing to a low Young's modulus of a resin, the resin sheet is liable to bend when a display surface of the display was pushed with a pen, a human finger, or the like. Therefore, the resin sheet causes a display failure through its contact with an internal display in some cases. The resin sheet also involves a problem of being liable to have flaws on its surfaces, resulting in easy reduction of visibility. A solution to those problems is to use a glass sheet as the protective member. The glass sheet for this application is required to, for example, (1) have a high mechanical strength, (2) have a low density and a light weight, (3) be able to be supplied at low cost in a large amount, (4) be excellent in bubble quality, (5) have a high light transmittance in a visible region, and (6) have a high Young's modulus so as not to bend easily when its surface is pushed with a pen, a finger, or the like. In particular, a glass sheet that does not satisfy the requirement (1) cannot serve as the protective member, and hence a tempered glass obtained by tempering through ion exchange treatment has been used as the protective member heretofore (see Patent Literatures 1 and 2, and Non Patent Literature 1).

The tempered glass is generally produced by a method comprising cutting a glass to be tempered so as to have a predetermined shape in advance and then subjecting the resultant to ion exchange treatment. In recent years, a method comprising subjecting a large sheet glass to be tempered to ion exchange treatment and then cutting the resultant so as to have a predetermined size has been under consideration. Herein, the former production method and the latter production method are distinguished from each other by referring to them as “pre-tempering cutting” and “post-tempering cutting,” respectively. In addition, when the post-tempering cutting is performed, manufacturing efficiency of each of the tempered glass and various devices dramatically improves, but breakage, an improper crack, or the like is liable to be generated at the time of the cutting owing to the presence of a compressive stress layer.

### CITATION LIST

### Patent Literature

[PTL 1] JP 2006-83045 A
[PTL 2] JP 2011-88763 A

### Non Patent Literature

[NPL 1] Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

As indicators for indicating tempering characteristics of a tempered glass, there are known a compressive stress (CS) and a depth of layer (DOL). In the case of pre-tempering cutting, it is important to increase the compressive stress (CS) and depth of layer (DOL) of the tempered glass as much as possible to the extent that spontaneous breakage due to an internal tensile stress does not occur at the time of the use of a device. On the other hand, in the case of post-tempering cutting, it is necessary to perform stress design so that no breakage or improper crack may be generated at the time of the cutting. Therefore, the pre-tempering cutting and the post-tempering cutting generally target different compressive stresses (CS) and depths of layer (DOL).

By the way, when a material for the glass to be tempered and the composition of an ion exchange solution are unchanged, the compressive stress (CS) and the depth of layer (DOL) are unambiguously determined by an ion exchange temperature and an ion exchange time. Accordingly, when the material for the glass to be tempered and the composition of the ion exchange solution are unchanged, it is difficult to increase the degree of freedom of stress design. It should be noted that a potassium nitrate solution is currently used as the ion exchange solution, and from the viewpoint of ion exchange efficiency, it is difficult to significantly change its composition.

In view of the foregoing, the material for the glass to be tempered has been generally changed depending on the required compressive stress (CS) and depth of layer (DOL). Specifically, for example, glasses to be tempered of different materials have been used in the post-tempering cutting and the pre-tempering cutting. However, the changing of the material for the glass to be tempered depending on the required compressive stress (CS) and depth of layer (DOL) leads to a wide variety of products in small quantities, and hence there is a risk in that manufacturing cost may soar. In other words, it can be said that when the degree of freedom of the stress design of the glass to be tempered of the same material can be increased, the same material can be used in the pre-tempering cutting and the post-tempering cutting, which is significantly advantageous in terms of manufacture.

The present invention has been made in view of the above-mentioned circumstances, and a technical object of the present invention is to devise a method by which the degree of freedom of the stress design of a tempered glass can be increased without changing the material for the glass to be tempered.

### Solution to Problem

The Inventor of the Present Invention has Made Extensive studies, and as a result, has found that the technical object can be achieved by subjecting a tempered glass to specific heat treatment. The finding is proposed as the present invention. That is, a method of manufacturing a tempered glass of the present invention includes: subjecting a glass to be tempered to ion exchange treatment to obtain a tempered glass having a compressive stress layer; and subjecting the tempered glass to heat treatment at a heat treatment temperature of 300° C. or more and less than (a temperature of the ion exchange treatment+10° C.) so that a compressive stress (CS) of the compressive stress layer becomes from 120 to 1,200 MPa. Herein, the “compressive stress (CS) of the compressive stress layer” and the “depth of layer (DOL)” are calculated on the basis of the number of interference fringes observed when a sample is observed using a surface stress meter (FSM-6000 manufactured by ORIHARA INDUSTRIAL CO., LTD.) and intervals therebetween. In addition, the “temperature of the ion exchange treatment” refers to, for example, the temperature of an ion exchange solution (such as potassium nitrate) used in the ion exchange treatment.

An investigation made by the inventor of the present invention has revealed that when the tempered glass after the ion exchange treatment is subjected to the specific heat treatment, ion exchange proceeds inside the tempered glass to lower the compressive stress (CS) of the compressive stress layer while increasing its depth of layer (DOL). For example, when CX-01 manufactured by Nippon Electric Glass Co., Ltd. is subjected to heat treatment at 380° C. for 100 minutes, the compressive stress (CS) lowers by about 30% and the depth of layer (DOL) increases by about 30%. This phenomenon can be utilized to vary the compressive stress (CS) and the depth of layer (DOL) even for the same material for the tempered glass. As a result, the degree of freedom of the stress design of the tempered glass can be increased.

Second, in the method of manufacturing a tempered glass of the present invention, it is preferred that the heat treatment temperature be lower than the temperature of the ion exchange treatment. With this, the values of the compressive stress (CS) and the depth of layer (DOL) can be easily controlled.

Third, in the method of manufacturing a tempered glass of the present invention, it is preferred that the heat treatment be performed for from 5 to 250 minutes. With this, the compressive stress (CS) and the depth of layer (DOL) can be easily varied without lowering manufacturing efficiency.

Fourth, it is preferred that the method of manufacturing a tempered glass of the present invention further comprise cutting the tempered glass after the heat treatment.

Fifth, in the method of manufacturing a tempered glass of the present invention, it is preferred that the ion exchange treatment and the heat treatment be continuously performed. With this, the manufacturing efficiency of the tempered glass can be increased. Herein, the phrase “the ion exchange treatment and the heat treatment are continuously performed” refers to, for example, the case where the tempered glass heated by the ion exchange treatment is subjected to the predetermined heat treatment before being cooled to an ordinary-temperature environment.

Sixth, in the method of manufacturing a tempered glass of the present invention, it is preferred that the subjecting the tempered glass to heat treatment be performed so that the compressive stress (CS) of the compressive stress layer becomes from 480 to 850 MPa. With this, post-tempering cutting can be easily performed while maintaining the mechanical strength of the tempered glass.

Seventh, in the method of manufacturing a tempered glass of the present invention, it is preferred that the subjecting the tempered glass to heat treatment be performed so that a depth of layer (DOL) of the compressive stress layer becomes from more than 17.0 to 35 μm. With this, post-tempering cutting can be easily performed while maintaining the mechanical strength of the tempered glass.

Eighth, in the method of manufacturing a tempered glass of the present invention, it is preferred that the glass to be tempered comprise as a glass composition, in terms of mass %, 40 to 71% of SiO₂, 7 to 23% of Al₂O₃, 0 to 1% of Li₂O, 7 to 20% of Na₂O, and 0 to 15% of K₂O. With this, ion exchange efficiency and denitrification resistance can both be achieved at high levels.

Ninth, in the method of manufacturing a tempered glass of the present invention, it is preferred that the glass to be tempered have an unpolished surface. It should be noted that the edge surfaces of the tempered glass may be subjected to polishing treatment, such as chamfering, or etching treatment.

Tenth, in the method of manufacturing a tempered glass of the present invention, it is preferred that the glass to be tempered be formed by an overflow down-draw method. Herein, the “overflow down-draw method” refers to a method comprising causing a molten glass to overflow from both sides of a heat-resistant forming trough, and subjecting the overflowing molten glasses to down-draw downward while the molten glasses are joined at the lower end of the forming trough, to thereby manufacture a glass sheet.

### BRIEF DESCRIPTION OF DRAWINGS

FIG. 1 shows data showing a relationship between a compressive stress (CS) and a heat treatment time in one embodiment of the present invention.

FIG. 2 shows data showing a relationship between a depth of layer (DOL) and a heat treatment time in one embodiment of the present invention.

### DESCRIPTION OF EMBODIMENTS

A method of manufacturing a tempered glass according to an embodiment of the present invention comprises: a tempering step of tempering a glass to be tempered to obtain a tempered glass; and a heat treatment step of further subjecting the tempered glass to heat treatment.

In the tempering step, the glass to be tempered is subjected to ion exchange treatment to obtain a tempered glass having a compressive stress layer. The ion exchange treatment is a method comprising introducing alkali ions each having a large ionic radius into a glass surface by ion exchange treatment at a temperature equal to or lower than the strain point of the glass to be tempered. According to the ion exchange treatment, the compressive stress layer can be formed even when the thickness of the glass to be tempered is small. As a result, desired mechanical strength can be obtained.

An ion exchange solution, an ion exchange temperature, and an ion exchange time may be determined in consideration of, for example, the viscosity characteristics of the glass to be tempered. In particular, when K ions in a potassium nitrate solution are subjected to ion exchange treatment with Na components in the glass to be tempered, the compressive stress layer can be efficiently formed in the glass surface.

In the heat treatment step, the tempered glass is subjected to heat treatment so as to have a compressive stress (CS) of from 120 to 1,200 MPa. The compressive stress (CS) after the heat treatment is preferably from 300 to 900 MPa, more preferably from 480 to 850 MPa, particularly preferably from 500 to 700 MPa. When the compressive stress (CS) after the heat treatment is less than 120 MPa, it is difficult to secure the mechanical strength of the tempered glass. On the other hand, when the compressive stress (CS) after the heat treatment is more than 1,200 MPa, it is difficult to appropriately perform post-tempering cutting.

In addition, in the heat treatment step, the tempered glass is preferably subjected to heat treatment so as to have a depth of layer (DOL) of from 15 to 45 μm, particularly preferably from more than 17.0 to 35 μm. When the depth of layer (DOL) after the heat treatment is less than 15 μm, it is difficult to secure the mechanical strength of the tempered glass. On the other hand, when the depth of layer (DOL) after the heat treatment is more than 45 μm, it is difficult to appropriately perform post-tempering cutting.

A heat treatment temperature in the heat treatment step is 300° C. or more and less than (the temperature of the ion exchange treatment+10° C.). The heat treatment temperature is preferably 350° C. or more and the temperature of the ion exchange treatment or less, more preferably 300° C. or more and (the temperature of the ion exchange treatment-10° C.) or less. When the heat treatment temperature is less than 300° C., the ranges within which the compressive stress (CS) and the depth of layer (DOL) can be varied reduce and it is difficult to increase the degree of freedom of the stress design of the tempered glass. When the heat treatment temperature is (the temperature of the ion exchange treatment+10° C.) or more, it is difficult to control the values of the compressive stress (CS) and the depth of layer (DOL). It should be noted that when the heat treatment temperature is excessively high, there is also a risk that the compressive stress layer may disappear or the tempered glass may undergo a dimensional change.

A heat treatment time in the heat treatment step is preferably from 5 to 250 minutes, more preferably from 10 to 200 minutes. When the heat treatment time is excessively short, the ranges within which the compressive stress (CS) and the depth of layer (DOL) can be varied reduce and it is difficult to increase the degree of freedom of the stress design of the tempered glass. On the other hand, when the heat treatment time is excessively long, the manufacturing efficiency of the tempered glass is liable to lower.

It is preferred that the ion exchange treatment in the tempering step and the heat treatment in the heat treatment step be continuously performed. In such embodiment, the two treatments are continuously performed by subjecting the tempered glass heated by the ion exchange treatment in the tempering step to the heat treatment in the heat treatment step before cooling the tempered glass to an ordinary-temperature environment. In this case, the heat treatment in the heat treatment step is performed while the tempered glass is out of contact with the ion exchange solution. In addition, from the viewpoint of manufacturing efficiency, it is preferred that: an ion exchange chamber and a preheated chamber be provided in a single furnace; and the tempered glass after the ion exchange treatment be subjected to the heat treatment by being transferred into the preheated chamber at a predetermined temperature and then kept for a predetermined period of time. In this case, when the preheated chamber is provided above the ion exchange chamber, the tempered glass pulled up from the ion exchange solution of the ion exchange chamber can be directly caused to be held in the preheated chamber through the utilization of the pull-up motion, and hence the tempered glass can be transferred more smoothly. The tempered glass may be held in a holder such as a basket and transferred together with the holder from the ion exchange chamber to the preheated chamber.

The heat treatment may be performed using, for example, a heat treatment furnace such as an electric furnace or a conveyor furnace.

After the heat treatment step, the tempered glass subjected to the heat treatment is preferably gradually cooled with a temperature gradient before being taken out to an ordinary-temperature environment. With this, a situation in which the tempered glass shrinks owing to rapid cooling can be avoided, and consequently, the tempered glass hardly undergoes breakage when being taken out.

The glass to be tempered (and the tempered glass) preferably comprise (s) as a glass composition, in terms of mass %, 40 to 71% of SiO₂, 7 to 23% of Al₂O₃, 0 to 1% of Li₂O, 7 to 20% of Na₂O, and 0 to 15% of K₂O. The reason why the content range of each component is limited as described above is described below. It should be noted that the expression “%” refers to “mass %” in the following description of the content range of each component unless otherwise specified.

SiO₂ is a component that forms a network of a glass. The content of SiO₂ is preferably from 40 to 71%, more preferably from 40 to 70%, more preferably from 40 to 63%, more preferably from 45 to 63%, more preferably from 50 to 59%, particularly preferably from 55 to 58.5%. When the content of SiO₂ is too large, it becomes difficult to melt and form the glass, and the thermal expansion coefficient becomes too low, with the result that it becomes difficult to match the thermal expansion coefficient with those of peripheral materials. On the other hand, when the content of SiO₂ is too small, vitrification does not occur easily. Further, the thermal expansion coefficient becomes large, and thermal shock resistance is liable to lower.

Al₂O₃ is a component that increases ion exchange performance, and has also an effect of increasing a strain point and a Young's modulus. The content of Al₂O₃ is from 7 to 23%. When the content of Al₂O₃ is too large, a devitrified crystal is liable to deposit in the glass and it becomes difficult to form the glass by an overflow down-draw method. Further, the thermal expansion coefficient becomes too low, with the result that it becomes difficult to match the thermal expansion coefficient with those of peripheral materials. In addition, the viscosity at high temperature rises, and it becomes difficult to melt the glass. When the content of Al₂O₃ is too small, sufficient ion exchange performance is not exhibited in some cases. From the above-mentioned viewpoints, the suitable upper limit range of Al₂O₃ is preferably 21% or less, more preferably 20% or less, more preferably 19% or less, more preferably 18% or less, more preferably 17% or less, particularly preferably 16.5% or less, and the suitable lower limit range of Al₂O₃ is preferably 7.5% or more, more preferably 8.5% or more, more preferably 9% or more, more preferably 10% or more, more preferably 11% or more, particularly preferably 12% or more.

Li₂O is an ion exchange component, and is also a component that lowers the viscosity at high temperature to increase meltability and formability. Further, Li₂O is a component that increases the Young's modulus. Further, Li₂O has a high effect of increasing the compressive stress (CS) among alkali metal oxides. However, when the content of Li₂O is too large, the liquidus viscosity lowers and the glass is liable to be devitrified. Further, the thermal expansion coefficient becomes too high, and the thermal shock resistance lowers, with the result that it becomes difficult to match the thermal expansion coefficient with those of peripheral materials. Further, when the viscosity at low temperature excessively lowers and stress relaxation easily occurs, the compressive stress (CS) may lower contrarily. Therefore, the content of Li₂O is preferably from 0 to 1%, more preferably from 0 to 0.5%, still more preferably from 0 to 0.1%. In particular, it is desired that the content of Li₂O be substantially zero, that is, be limited to less than 0.01%.

Na₂O is an ion exchange component, and is also a component that lowers the viscosity at high temperature to increase the meltability and the formability. Further, Na₂O is also a component improving devitrification resistance. The content of Na₂O is preferably from 7 to 20%, more preferably from 10 to 20%, more preferably from 10 to 19%, more preferably from 12 to 19%, more preferably from 12 to 17%, more preferably from 13 to 17%, particularly preferably from 14 to 17%. When the content of Na₂O is too large, the thermal expansion coefficient becomes too high, and the thermal shock resistance lowers, with the result that it becomes difficult to match the thermal expansion coefficient with those of peripheral materials. Further, there are tendencies that the strain point excessively lowers, and the glass composition loses its component balance, with the result that the devitrification resistance lowers contrarily. On the other hand, when the content of Na₂O is small, the meltability lowers, the thermal expansion coefficient becomes too low, and the ion exchange performance is liable to lower.

K₂O is a component that has an effect of promoting ion exchange, and has a high effect of increasing a depth of layer among alkali metal oxides. Further, K₂O is a component that lowers the viscosity at high temperature to increase the meltability and the formability. K₂O is also a component that improves the devitrification resistance. The content of K₂O is preferably from 0 to 15%. When the content of K₂O is too large, the thermal expansion coefficient becomes high, and the thermal shock resistance lowers, with the result that it becomes difficult to match the thermal expansion coefficient with those of peripheral materials. Further, there are tendencies that the strain point excessively lowers, and the glass composition loses its component balance, with the result that the devitrification resistance lowers contrarily. Therefore, the upper limit range of K₂O is preferably 12% or less, more preferably 10% or less, more preferably 8% or less, particularly preferably 6% or less.

When the total content of alkali metal oxides R₂O (R represents one or more kinds selected from Li, Na, and K) is too large, the glass is liable to be devitrified. In addition, the thermal expansion coefficient becomes too high, and the thermal shock resistance lowers, with the result that it becomes difficult to match the thermal expansion coefficient with those of peripheral materials. Further, when the total content of the alkali metal oxides R₂O is too large, the strain point excessively lowers, and a high compressive stress (CS) is not obtained in some cases. Further, the viscosity around the liquidus temperature lowers, and it becomes difficult to secure a high liquidus viscosity in some cases. Therefore, the total content of R₂O is preferably 22% or less, more preferably 20% or less, particularly preferably 19% or less. On the other hand, when the total content of R₂O is too small, the ion exchange performance and the meltability lower in some cases. Therefore, the total content of R₂O is preferably 8% or more, more preferably 10% or more, more preferably 13% or more, particularly preferably 15% or more.

In addition to the components described above, the following components may be added.

For example, alkaline earth metal oxides R′O (R′ represents one or more kinds selected from Mg, Ca, Sr, and Ba) are components that may be added for various purposes. However, when the total content of the alkaline earth metal oxides R′O becomes large, the density and the thermal expansion coefficient become high, and the denitrification resistance lowers. In addition, the ion exchange performance tends to lower. Therefore, the total content of the alkaline earth metal oxides R′O is preferably from 0 to 9.9%, more preferably from 0 to 8%, more preferably from 0 to 6%, particularly preferably from 0 to 5%.

MgO is a component that lowers the viscosity at high temperature to increase the meltability and the formability, or to increase the strain point and the Young's modulus, and has a high effect of improving the ion exchange performance among alkaline earth metal oxides. However, when the content of MgO becomes large, the density and the thermal expansion coefficient increase, and the glass is liable to be devitrified. The content of MgO is preferably from 0 to 9%, particularly preferably from 1 to 8%.

CaO is a component that lowers the viscosity at high temperature to increase the meltability and the formability, or to increase the strain point and the Young's modulus, and has a high effect of improving the ion exchange performance among alkaline earth metal oxides. The content of CaO is preferably from 0 to 6%. However, when the content of CaO becomes large, the density and the thermal expansion coefficient increase, and the glass is liable to be devitrified. In addition, the ion exchange performance lowers in some cases. Therefore, the content of CaO is preferably from 0 to 4%, more preferably from 0 to 3%, more preferably from 0 to 2%, more preferably from 0 to 1%, particularly preferably from 0 to 0.1%.

SrO and BaO are components that lower the viscosity at high temperature to increase the meltability and the formability, or to increase the strain point and the Young's modulus. The content of each of SrO and BaO is preferably from 0 to 3%. When the content of each of SrO and BaO becomes large, the ion exchange performance tends to lower. Further, the density and the thermal expansion coefficient increase, and the glass is liable to be devitrified. The content of SrO is preferably 2% or less, more preferably 1.5% or less, more preferably 1% or less, more preferably 0.5% or less, more preferably 0.2% or less, particularly preferably 0.1% or less. In addition, the content of BaO is preferably 2.5% or less, more preferably 2% or less, more preferably 1% or less, more preferably 0.8% or less, more preferably 0.5% or less, more preferably 0.2% or less, particularly preferably 0.1% or less.

ZrO₂ has effects of remarkably improving the ion exchange performance and simultaneously, increasing the Young's modulus and the strain point, and lowering the viscosity at high temperature. Further, ZrO₂ has an effect of increasing the viscosity around the liquidus viscosity. Therefore, by inclusion of a given amount of ZrO₂, the ion exchange performance and the liquidus viscosity can be improved simultaneously. However, when the content of ZrO₂ is too large, the denitrification resistance remarkably lowers in some cases. Thus, the content of ZrO₂ is preferably from 0 to 10%, more preferably from 0.001 to 10%, more preferably from 0.1 to 9%, more preferably from 0.5 to 7%, more preferably from 0.8 to 5%, more preferably from 1 to 5%, particularly preferably from 2.5 to 5%.

B₂O₃ has an effect of lowering the liquidus temperature, the viscosity at high temperature, and the density, and has an effect of improving the ion exchange performance, in particular, the compressive stress (CS). However, when the content of B₂O₃ is too large, there are risks in that weathering occurs on the surface by ion exchange treatment, the water resistance lowers, and the liquidus viscosity lowers. Further, the depth of layer tends to lower. Therefore, the content of B₂O₃ is preferably from 0 to 6%, more preferably from 0 to 3%, more preferably from 0 to 1%, more preferably from 0 to 0.5%, particularly preferably from 0 to 0.1%.

TiO₂ is a component having an effect of improving the ion exchange performance. Further, TiO₂ has an effect of lowering the viscosity at high temperature. However, when the content of TiO₂ becomes too large, the glass is colored, the devitrification property lowers, and the density becomes high. Particularly in the case of using the glass as a cover glass for a display, if the content of TiO₂ becomes large, the transmittance is liable to change when the melting atmosphere or raw materials are altered. Therefore, in a process for causing a tempered glass to adhere to a device by utilizing light with a UV-curable resin or the like, ultraviolet irradiation conditions are liable to vary and stable production becomes difficult. Therefore, the content of TiO₂ is preferably 10% or less, more preferably 8% or less, more preferably 6% or less, more preferably 5% or less, more preferably 4% or less, more preferably 2% or less, more preferably 0.7% or less, more preferably 0.5% or less, more preferably 0.1% or less, particularly preferably 0.01% or less.

P₂O₅ is a component that increases the ion exchange performance, and in particular, has a high effect of increasing a stress thickness. However, when the content of P₂O₅ becomes large, the glass manifests phase separation, and the water resistance and the devitrification resistance are liable to lower. Thus, the content of P₂O₅ is preferably 5% or less, more preferably 4% or less, more preferably 3% or less, particularly preferably 2% or less.

As the fining agent, one kind or two or more kinds selected from the group consisting of As₂O₃, Sb₂O₃, CeO₂, F, SO₃, and Cl may be contained in an amount of from 0.001 to 3%. It is preferred to refrain as much as possible from the use of As₂O₃ and Sb₂O₃, from the standpoint of environmental considerations. Thus, the content of each of As₂O₃ and Sb₂O₃ is limited to desirably less than 0.1%, more desirably less than 0.01%. In addition, CeO₂ is a component that lowers the transmittance. Thus, the content of CeO₂ is limited to desirably less than 0.1%, more desirably less than 0.01%. In addition, F may lower the viscosity at low temperature and lower the compressive stress (CS). Thus, the content of F is limited to preferably less than 0.1%, particularly preferably less than 0.01%. Therefore, SO₃ and Cl are preferred fining agents, and one or both of SO₃ and Cl is/are added in an amount of preferably from 0.001 to 3%, more preferably from 0.001 to 1%, more preferably from 0.01 to 0.5%, particularly preferably from 0.05 to 0.4%.

Rare earth oxides such as Nb₂O₅ and La₂O₃ are components that increase the Young's modulus. However, the cost of the raw material itself is high, and when the rare earth oxides are contained in large amounts, the denitrification resistance lowers. Therefore, the content of the rare earth oxides is preferably 3% or less, more preferably 2% or less, more preferably 1% or less, more preferably 0.5% or less, particularly preferably 0.1% or less.

Transition metal elements causing intense coloration of a glass, such as Co and Ni, may lower the transmittance of the tempered glass. In particular, in the case of using the transition metal elements in a touch panel display application, when the content of the transition metal elements is large, the visibility of a tough panel display is impaired. Specifically, it is desired that the use amount of raw materials or cullet be adjusted so that the content of the transition metal elements is preferably 0.5% or less, more preferably 0.1% or less, particularly preferably 0.05% or less.

In the glass to be tempered according to this embodiment, the density is preferably 2.6 g/cm³ or less, particularly preferably 2.55 g/cm³ or less. As the density becomes smaller, the weight of the tempered glass can be reduced more. It should be noted that the density is easily reduced by increasing the content of SiO₂, B₂O₃, or P₂O₅ in the glass composition or by reducing the content of an alkali metal oxide, an alkaline earth metal oxide, ZnO, ZrO₂, or TiO₂ in the glass composition.

In the glass to be tempered (and tempered glass) according to this embodiment, the thermal expansion coefficient is preferably 80×10⁻⁷ to 120×10⁻⁷/° C., more preferably 85×10⁻⁷ to 110×10⁻⁷/° C., more preferably 90×10⁻⁷ to 110×10⁻⁷/° C., particularly preferably 90×10⁻⁷ to 105×10⁻⁷/° C. When the thermal expansion coefficient is controlled within the above-mentioned ranges, it becomes easy to match the thermal expansion coefficient with those of members made of a metal, an organic adhesive, and the like, and the members made of a metal, an organic adhesive, and the like are easily prevented from being peeled off. Herein, the “thermal expansion coefficient” refers to a value obtained through measurement of an average thermal expansion coefficient in the temperature range of from 30 to 380° C. with a dilatometer. It should be noted that the thermal expansion coefficient is easily increased by increasing the content of an alkali metal oxide or an alkaline earth metal oxide in the glass composition, and in contrast, the thermal expansion coefficient is easily decreased by reducing the content of the alkali metal oxide or the alkaline earth metal oxide.

In the glass to be tempered (and tempered glass) according to this embodiment, the strain point is preferably 500° C. or more, more preferably 520° C. or more, more preferably 530° C. or more, particularly preferably 550° C. or more. As the strain point becomes higher, the heat resistance is improved more, and the disappearance of the compressive stress layer more hardly occurs when the tempered glass is subjected to heat treatment. Further, a high-quality film can be easily formed in patterning to form a touch panel sensor or the like. It should be noted that the strain point is easily increased by increasing the content of an alkaline earth metal oxide, Al₂O₂, ZrO₂, or P₂O₅ in the glass composition or by reducing the content of an alkali metal oxide in the glass composition.

In the glass to be tempered (and tempered glass) according to this embodiment, the temperature at 10^{4.0} dPa·s is preferably 1,280° C. or less, more preferably 1,230° C. or less, more preferably 1,200° C. or less, more preferably 1,180° C. or less, particularly preferably 1,160° C. or less. As the temperature at 10^{4.0} dPa·s becomes lower, a burden on forming equipment is reduced more, the forming equipment has a longer life, and consequently, the manufacturing cost of the tempered glass is more likely to be reduced. It should be noted that the temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

In the glass to be tempered (and tempered glass) according to this embodiment, the temperature at 10^{2.5} dPa·s is preferably 1,620° C. or less, more preferably 1,550° C. or less, more preferably 1,530° C. or less, more preferably 1,500° C. or less, particularly preferably 1,450° C. or less. As the temperature at 10^{2.5} dPa·s becomes lower, melting at lower temperature can be carried out, and hence a burden on glass manufacturing equipment such as a melting furnace is reduced more, and the bubble quality is easily improved more. Thus, as the temperature at 10^{2.5} dPa·s becomes lower, the manufacturing cost of the tempered glass is more likely to be reduced. It should be noted that the temperature at 10^{2.5} dPa·s corresponds to a melting temperature. Further, the temperature at 10^{2.5} dPa·s is easily decreased by increasing the content of an alkali metal oxide, an alkaline earth metal oxide, ZnO, B₂O₃, or TiO₂ in the glass composition or by reducing the content of SiO₂ or Al₂O₃ in the glass composition.

In the glass to be tempered (and tempered glass) according to this embodiment, the liquidus temperature is preferably 1,200° C. or less, more preferably 1,150° C. or less, more preferably 1,100° C. or less, more preferably 1,050° C. or less, more preferably 1,000° C. or less, more preferably 950° C. or less, more preferably 900° C. or less, particularly preferably 880° C. or less. It should be noted that as the liquidus temperature becomes lower, the devitrification resistance and the formability are improved more. Further, the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂ in the glass composition.

In the glass to be tempered (tempered glass) according to this embodiment, the liquidus viscosity is preferably 10^{4.0} dPa·s or more, more preferably 10^{4.4} dPa·s or more, more preferably 10^{4.8} dPa·s or more, more preferably 10^{5.0} dPa·s or more, more preferably 10^{5.4} dPa·s or more, more preferably 10^{6.2} dPa·s or more, more preferably 10^{6.0} dPa·s or more, more preferably 10^{6.2} dPa·s or more, particularly preferably 10^{6.3} dPa·s or more. It should be noted that as the liquidus viscosity becomes higher, the devitrification resistance and the formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

The tempered glass according to this embodiment preferably has an unpolished surface, and it is particularly preferred that both surfaces thereof be unpolished. In addition, the unpolished surface has an average surface roughness (Ra) of preferably 10 Å or less, more preferably 5 Å or less, more preferably 4 Å or less, still more preferably 3 Å or less, most preferably 2 Å or less. It should be noted that the average surface roughness (Ra) may be measured by a method in conformity with SEMI D7-97 “FPD Glass Substrate Surface Roughness Measurement Method.” Glass originally has extremely high theoretical strength, but often breaks even under a stress far lower than the theoretical strength. This is because a small flaw called a Griffith flaw is generated in a glass surface in a step after forming, such as a polishing step. Therefore, when the surface of the tempered glass is left unpolished, the original mechanical strength of the tempered glass is maintained and the tempered glass hardly undergoes breakage. In addition, in the case of performing the post-tempering cutting, when the surface is left unpolished, an improper crack, breakage, or the like is hardly generated at the time of the cutting. Further, when the surface of the tempered glass is left unpolished, the polishing step can be omitted, and hence the manufacturing cost of the glass to be tempered can be reduced. It should be noted that in order to obtain the unpolished surface, it is recommended to perform forming of the glass to be tempered by an overflow down-draw method.

The edge surfaces of the tempered glass according to this embodiment are preferably subjected to chamfering processing, etching treatment, or the like in order to prevent a situation in which breakage occurs from any of the edge surfaces.

In the glass to be tempered (and tempered glass) according to this embodiment, the thickness (sheet thickness in the case of a sheet shape) is preferably 3.0 mm or less, more preferably 2.0 mm or less, more preferably 1.5 mm or less, more preferably 1.3 mm or less, more preferably 1.1 mm or less, more preferably 1.0 mm or less, more preferably 0.8 mm or less, particularly preferably 0.7 mm or less. On the other hand, when the thickness is too small, the warpage level tends to be larger and a desired mechanical strength is hardly provided. Thus, the thickness is preferably 0.1 mm or more, more preferably 0.2 mm or more, more preferably 0.3 mm or more, particularly preferably 0.4 mm or more.

It is preferred that the glass to be tempered (and tempered glass) according to this embodiment be formed by an overflow down-draw method. With this, glass having satisfactory surface quality in an unpolished state can be formed. This is because in the case of the overflow down-draw method, a surface that is to serve as a surface of a glass sheet is formed in a state of a free surface without being brought into contact with a trough-shaped refractory. Further, according to the overflow down-draw method, a glass sheet having a thickness of 0.5 mm or less can be appropriately formed. The structure and material of the trough-shaped structure are not particularly limited as long as desired dimensions and surface quality can be achieved. In addition, a method of applying a force to the glass in order to down-draw the glass downward is not particularly limited as long as desired dimensions and surface quality can be achieved. For example, there may be adopted a method comprising rotating a heat-resistant roll having a sufficiently large width in the state of being in contact with the glass, to thereby draw the glass, or there may be adopted a method comprising bringing a plurality of paired heat-resistant rolls into contact with only the vicinity of the edge surfaces of the glass, to thereby draw the glass.

The glass to be tempered (and tempered glass) according to this embodiment may be formed by a method other than the overflow down-draw method, such as a slot down-draw method, a float method, a roll-out method, or a re-draw method. Particularly in the case of forming the glass to be tempered (and tempered glass) by the float method, a large-size glass sheet can be produced at low cost.

### Examples

Hereinafter, Examples of the present invention are described. It should be noted that Examples shown below are merely illustrative. The present invention is by no means limited to Examples shown below.

Table 1 shows Examples (Sample Nos. 2 to 5) and Comparative Example (Sample No. 1) of the present invention.

TABLE 1

| | Comparative | | | | |
|---|---|---|---|---|---|
| | Example | Example | | | |
| | No. 1 | No. 2 | No. 3 | No. 4 | No. 5 |
| Heat treatment | — | 380 | 380 | 380 | 380 |
| temperature (° C.) | | | | | |
| Heat treatment | — | 10 | 80 | 100 | 180 |
| time | | | | | |
| CS (MPa) | 860 | 846 | 670 | 624 | 520 |
| DOL (μm) | 17 | 17.5 | 21.6 | 22.3 | 24 |

First, a glass to be tempered of a sheet shape having dimensions of 40 mm×80 mm×0.7 mm in thickness was prepared. This glass to be tempered comprised as a glass composition, in terms of mass %, 57.4% of SiO₂, 13% of Al₂O₃, 2% of B₂O₃, 2% of MgO, 2% of CaO, 0.1% of Li₂O, 14.5% of Na₂O, 5% of K₂O, and 4% of ZrO₂.

This glass to be tempered was formed by an overflow down-draw method and had an unpolished surface.

The glass to be tempered was subjected to ion exchange treatment by being immersed in a potassium nitrate solution at 400° C. for 80 minutes to obtain a tempered glass.

Next, the obtained tempered glass was transferred to a chamber kept at 380° C., and subjected to heat treatment for a predetermined period of time (10 minutes, 80 minutes, 100 minutes, or 180 minutes). After the heat treatment, the tempered glass was taken out to an ordinary-temperature environment. Thus, each of Samples Nos. 2 to 5 was obtained. It should be noted that Sample No. 1 was taken out to an ordinary-temperature environment after the ion exchange treatment without being subjected to the heat treatment.

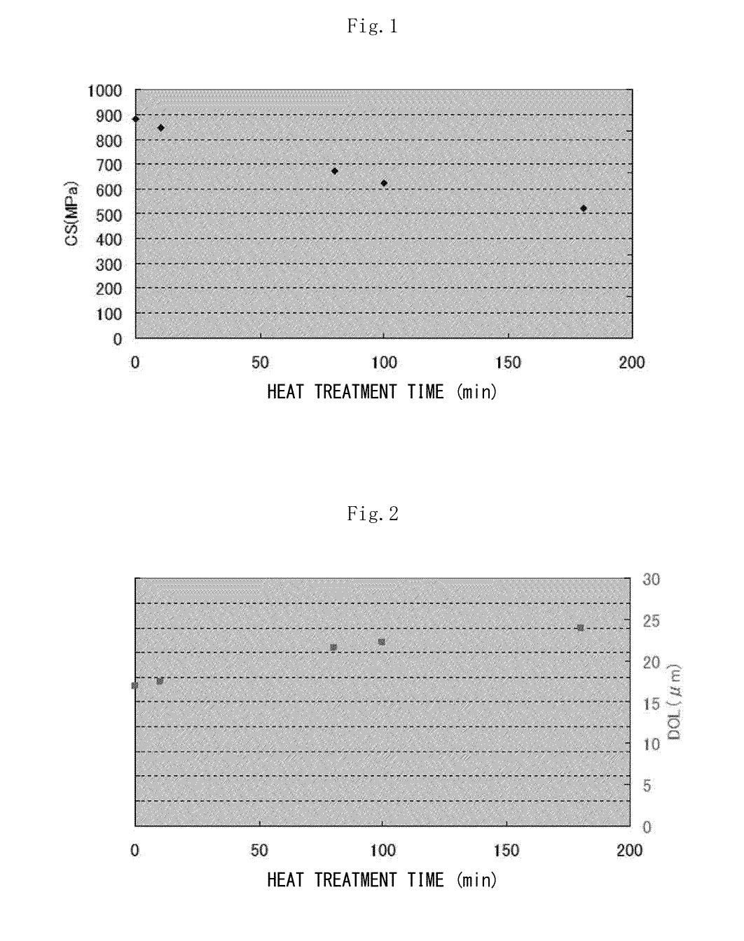

Each of the samples was washed, and then its compressive stress (CS) and depth of layer (DOL) were calculated on the basis of the number of interference fringes observed using a surface stress meter (FSM-6000 manufactured by ORIHARA INDUSTRIAL CO., LTD.) and intervals therebetween. In the calculation, the refractive index and optical elastic constant of each of the samples were defined as 1.53 and 28 [(nm/cm)/MPa], respectively. Table 1, FIG. 1, and FIG. 2 show the results.

As apparent from Table 1, FIG. 1, and FIG. 2, when the tempered glass is subjected to the heat treatment after the ion exchange treatment, the compressive stress (CS) lowers and the depth of layer (DOL) increases. In addition, as the heat treatment time lengthens, the compressive stress (CS) lowers and the depth of layer (DOL) increases. Therefore, it is found that the compressive stress (CS) and the depth of layer (DOL) can be varied by subjecting the tempered glass to the predetermined heat treatment.

Scribe lines were formed on each of Samples Nos. 2 to 5 with a diamond tip at a speed of 50 mm/sec, and then each of the samples was subjected to a snapping operation so as to have dimensions of 40 mm×40 mm×0.7 mm in thickness. As a result, no defect such as breakage was generated.

### INDUSTRIAL APPLICABILITY

According to the method of manufacturing a tempered glass of the present invention, a cover glass for a cellular phone, a digital camera, a PDA, a solar cell, or the like, or a substrate for a touch panel display can be suitably produced. Further, the method of manufacturing a tempered glass of the present invention can be expected to find use in applications requiring a high mechanical strength, for example, a window glass, a substrate for a magnetic disk, a substrate for a flat panel display, a cover glass for a solid image pick-up element, and tableware, in addition to the above-mentioned applications.

1. A method of manufacturing a tempered glass, comprising:
subjecting a glass to be tempered to ion exchange treatment to obtain a tempered glass having a compressive stress layer; and
subjecting the tempered glass to heat treatment at a heat treatment temperature of 300° C. or more and less than (a temperature of the ion exchange treatment+10° C.) so that a compressive stress (CS) of the compressive stress layer becomes from 120 to 1,200 MPa.

2. The method of manufacturing a tempered glass according to claim 1, wherein the heat treatment temperature is lower than the temperature of the ion exchange treatment.

3. The method of manufacturing a tempered glass according to claim 1, wherein the heat treatment is performed for from 5 to 250 minutes.

4. The method of manufacturing a tempered glass according to claim 1, further comprising cutting the tempered glass after the heat treatment.

5. The method of manufacturing a tempered glass according to claim 1, wherein the ion exchange treatment and the heat treatment are continuously performed.

6. The method of manufacturing a tempered glass according to claim 1, wherein the subjecting the tempered glass to heat treatment is performed so that the compressive stress (CS) of the compressive stress layer becomes from 480 to 850 MPa.

7. The method of manufacturing a tempered glass according to claim 1, wherein the subjecting the tempered glass to heat treatment is performed so that a depth of layer (DOL) of the compressive stress layer becomes from more than 17.0 to 35 μm.

8. The method of manufacturing a tempered glass according to claim 1, wherein the glass to be tempered comprises as a glass composition, in terms of mass %, 40 to 71% of SiO₂, 7 to 23% of Al₂O₃, 0 to 1% of Li₂O, 7 to 20% of Na₂O, and 0 to 15% of K₂O.

9. The method of manufacturing a tempered glass according to claim 1, wherein the glass to be tempered has an unpolished surface.

10. The method of manufacturing a tempered glass according to claim 1, wherein the glass to be tempered is formed by an overflow down-draw method.

11. The method of manufacturing a tempered glass according to claim 2, wherein the heat treatment is performed for from 5 to 250 minutes.

12. The method of manufacturing a tempered glass according to claim 2, further comprising cutting the tempered glass after the heat treatment.

13. The method of manufacturing a tempered glass according to claim 2, wherein the ion exchange treatment and the heat treatment are continuously performed.

14. The method of manufacturing a tempered glass according to claim 2, wherein the subjecting the tempered glass to heat treatment is performed so that the compressive stress (CS) of the compressive stress layer becomes from 480 to 850 MPa.

15. The method of manufacturing a tempered glass according to claim 2, wherein the subjecting the tempered glass to heat treatment is performed so that a depth of layer (DOL) of the compressive stress layer becomes from more than 17.0 to 35 μm.

16. The method of manufacturing a tempered glass according to claim 2, wherein the glass to be tempered comprises as a glass composition, in terms of mass %, 40 to 71% of SiO₂, 7 to 23% of Al₂O₃, 0 to 1% of Li₂O, 7 to 20% of Na₂O, and 0 to 15% of K₂O.

17. The method of manufacturing a tempered glass according to claim 2, wherein the glass to be tempered has an unpolished surface.

18. The method of manufacturing a tempered glass according to claim 2, wherein the glass to be tempered is formed by an overflow down-draw method.
